(19) United States
(12) Patent Application Publication
(10) Pub. No.: US 2015/0061566 A1
(43) Pub. Date: Mar. 5, 2015

(54) CONTROL CIRCUIT FOR DRIVING MOTOR AND METHOD FOR CONTROLLING SPEED OF MOTOR

(71) Applicant: SYSTEM GENERAL CORP., Taipei City (TW)

(72) Inventors: Ta-Yung Yang, Milpitas, CA (US); Yu-Cheng Kang, Taipei City (TW); Yung-Sheng Wu, New Taipei City (TW); Pei-Yu Chiang, New Taipei City (TW)

(21) Appl. No.: 14/474,313

(22) Filed: Sep. 2, 2014

Related U.S. Application Data
(60) Provisional application No. 61/872,997, filed on Sep. 3, 2013.

(51) Int. Cl. H02P 6/08; H02P 23/14

(52) U.S. Cl. CPC H02P 6/08; H02P 23/14
USPC 318/721

(57) ABSTRACT

A control circuit for driving a motor and a method for controlling a speed of a motor are provided. The control circuit comprises a microcontroller and a drive circuit. The microcontroller has a memory. The drive circuit is configured to drive the BLDC motor according to a control of the microcontroller. The memory include a RPM table, and the microcontroller sends a duty signal to the drive circuit to change a speed of the motor according to the RPM table.

### CROSS REFERENCE TO RELATED APPLICATION

This application claims the priority benefits of U.S. provisional application Ser. No. 61/872,997, filed on Sep. 3, 2013. The entirety of the above-mentioned patent application is hereby incorporated by reference herein and made a part of this specification.

### BACKGROUND OF THE INVENTION

1. Field of the Invention

The present invention relates to techniques for brushless DC (BLDC) motor, and particularly to a control circuit for driving the BLDC motor and a method for controlling the speed of the BLDC motor.

2. Related Art

Brushless DC (BLDC) motor are synchronous motors that are powered by a DC electric source via an integrated inverter/switching power supply, which produces an AC electric signal to drive the motor. The BLDC motor and its mechanical parts normally will be resonant to specific frequencies. This resonant phenomenal will cause a reliability problem for the motor and/or generate the acoustic noise. The object of the present invention is to solve this problem.

### SUMMARY OF THE INVENTION

The present invention provides a control circuit for driving a brushless DC (BLDC) motor. The control circuit comprises a microcontroller having a memory, and a drive circuit. The drive circuit is configured to drive the BLDC motor according to a control of the microcontroller. The memory include a RPM table, and the microcontroller sends a duty signal to the drive circuit to change a speed of the motor according to the RPM table.

From another point of view, the present invention provides a method for controlling a speed of a BLDC motor. The method includes following steps. A control signal is generated according to a RPM table in a memory. The BLDC motor is driven according to the control signal. The control signal is generated by a microcontroller, and the control signal is configured to drive the BLDC motor through a drive circuit.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 shows a block diagram illustrating a control circuit for driving a BLDC motor according to one embodiment of the present invention.

FIG. 2 shows the angle detection and the PWM operation for a sensorless motor control of the BLDC motor according to one embodiment of the present invention.

FIG. 3 shows a schematic diagram illustrating a RPM table (RpmTable) stored in the memory according to one embodiment of the present invention.

FIG. 4 shows a control flow illustrating the microcontroller according to one embodiment of the present invention.

FIG. 5 shows the waveforms generated by the sine-wave generator according to one embodiment of the present invention.

### DETAILED DESCRIPTION OF EMBODIMENTS

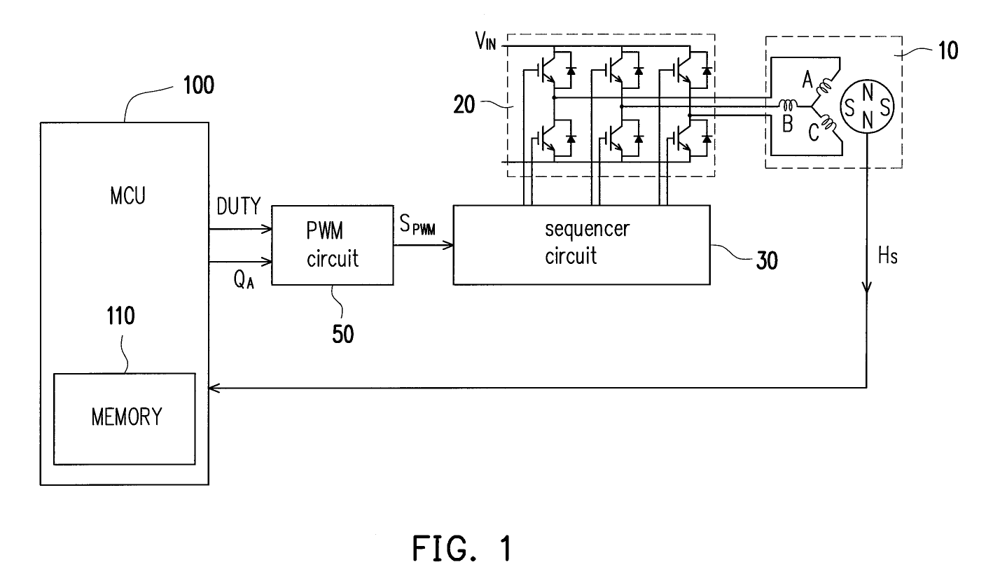

FIG. 1 shows a block diagram illustrating a control circuit for driving a BLDC motor 10 according to one embodiment of the present invention. The control circuit includes a three-phase bridge driver 20, a sequencer circuit 30, a microcontroller (MCU) 100, and a pulse width modulation (PWM) circuit 50. The microcontroller 100 has a memory 110 including a program memory and a data memory. The microcontroller 100 generates a duty signal DUTY (i.e., a control signal) and an angle signal θ_{A} according to a signal H_{S}. The signal H_{S} is related to the BLDC motor's position and speed. The duty signal DUTY and an angle signal θ_{A} are coupled to the PWM circuit 50 for generating a signal SPWM. The signal S_{PWM} is configured to control the three-phase bridge driver 20 through the sequencer circuit 30 for driving the BLDC motor 10. The three-phase bridge driver 20 receives an input signal V_{IN} to drive the BLDC motor 10. The PWM circuit 50, the three-phase bridge driver 20, and the sequencer circuit 30 form a drive circuit for driving the BLDC motor 10. The drive circuit is configured to drive the BLDC motor 10 according to the control of the microcontroller 100. In the embodiment of the present invention, the BLDC motor 10 is a permanent magnet synchronous motor (PMSM).

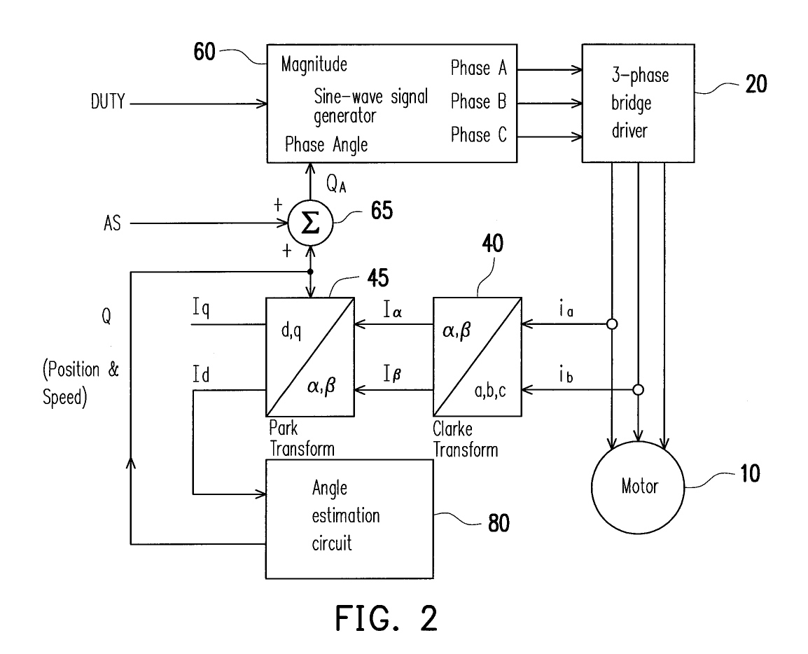

FIG. 2 shows the angle detection and the PWM operation for a sensorless motor control of the BLDC motor 10 according to one embodiment of the present invention. The circuit for the angle detection and the PWM operation includes the Clarke transform module 40, the Park transform module 45, a sine-wave signal generator 60, an angle estimation module 80, and a sum unit 65. The Clarke transform module 40 is configured to transform a three-axis, two-dimensional coordinate system (referenced to the stator a, b, c) to a two-axis coordinate system. In other words, the Clarke transform module 40 receives phase currents iₐ, i_{b}, and i_{c} of the motor 10 to generate two-axis orthogonal currents iα, iβ for mapping the motor's phase currents of iₐ, i_{b} and i_{c}. The Park transform module 45 generates signals I_{d} and I_{q} according to the two-axis orthogonal currents i_{α} and i_{β}. The angle estimation module 80 generates an angle signal θ in accordance with the signal I_{d}. The angle signal θ is further feedback to Park transform module 45. The sum unit 65 generates another angle signal θ_{A} in accordance with the angle signal θ and an angle-shift signal AS. The angle-shift signal AS is used for adapting to various BLDC motors, and/or for the weak-magnet control. The angle signal θ includes the information of the motor's position and speed.

The angle signal θ_{A} and the duty signal DUTY are coupled to the sine-wave generator 60 for generating the pulse-width modulation signals and 3-phase motor voltage signals (phase A, phase B and phase C). The 3-phase motor voltage signals (phase A, phase B and phase C) are configured to drive the BLDC motor 10 through the three-phase bridge driver 20. The sine-wave generator 60 has two inputs including a magnitude input and a phase angle input. The magnitude input is coupled to the duty signal DUTY. The phase angle input is coupled to the angle signal θA.

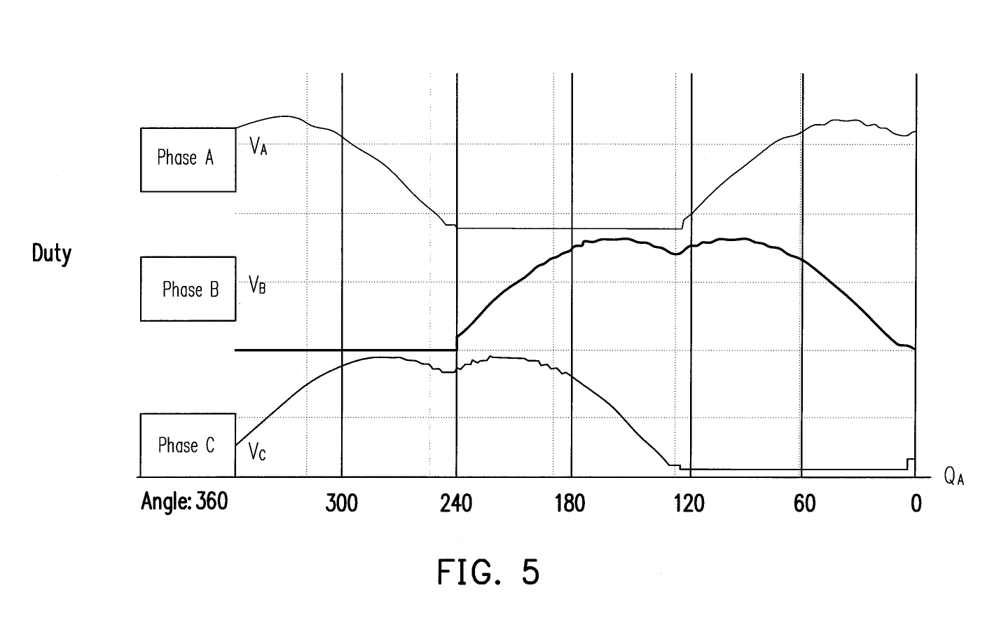

FIG. 5 shows the waveforms generated by the sine-wave generator 60 according to one embodiment of the present invention. The amplitude of 3-phase motor voltage signals V_{A}, V_{B}, V_{C} is programmed by the duty signal DUTY. The angle of 3-phase motor voltage signals V_{A}, V_{B}, V_{C} is determined by the angle signal θ_{A}.

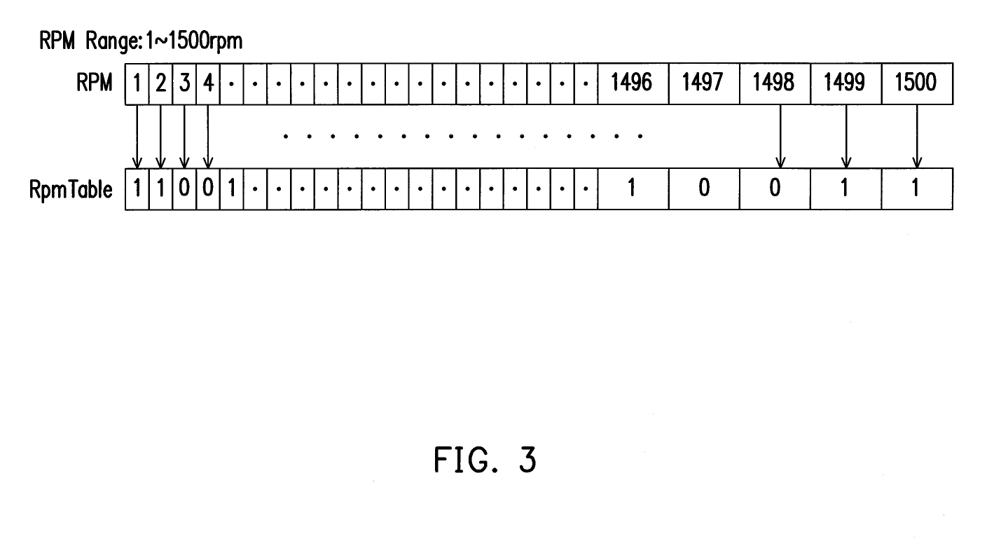

FIG. 3 shows a schematic diagram illustrating a RPM table (RpmTable) stored in the memory 110 according to one embodiment of the present invention. The revolution per minute (RPM) represents the speed of the motor. The logic 1 stored in the RpmTable indicates that the RPM is allowed. The logic 0 stored in the RpmTable indicates that the RPM is inhibited. The microcontroller 100 in FIG. 1 sends the duty signal DUTY to the drive circuit to change the speed of the motor 10 according to the RPM table in FIG. 3.

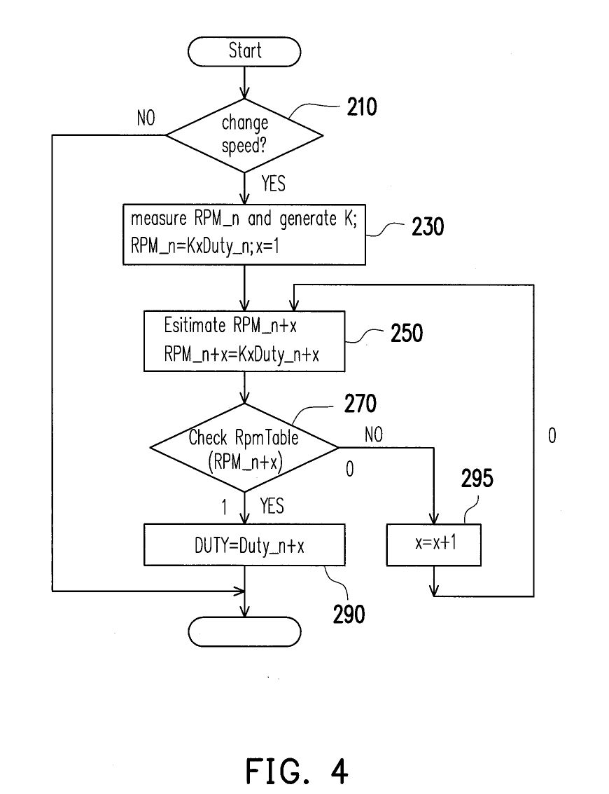

FIG. 4 shows a control flow illustrating the microcontroller 100 according to one embodiment of the present invention. From the start step 200, in step 210, the MCU 100 in FIG. 1 checks if the change of the speed of the motor 10 is required. A flag YES represents the change of the speed is required. The flag NO represents the change of the speed is not required. If the flag is YES, then the MCU 100 will set a variable x as 1 and measure the RPM value of the motor 10 for generating a constant K in step 230. The constant K is calculated by the formula (1).

$$K = \frac{RPM\_n}{Duty\_n} \qquad ( 1 )$$

The parameter Duty_n is the level of the duty signal DUTY that generates the RPM value of RPM_n.

After the step 230, in step 250, the MCU 100 will estimate the next RPM value of RPM_n+x according to three parameters: (1) the constant K, (2) the variable x, and (3) the next step's level (Duty_n+x) of the duty signal DUTY. The next RPM value of RPM_n+x is calculated by the formula (2).

(RPM_{—}n+x)=k×(Duty_{—}n+x) (2)

According the RPM_n+x, the MCU 100 will check the RPM table (RpmTable) in the memory 110 in step 270. If the RpmTable shows the RPM_n+x is allowed (logic 1), then the MCU 100 will set the level of the duty signal DUTY as Duty_n+x in step 290. If the RpmTable shows the RPM_n+x is inhibited (logic 0), then the MCU 100 will set the variable x as x+1 in step 295, and go to execute the step 250. Therefore, the motor 10 can be operated without running at the speed of the resonant frequency of the motor 10.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. A control circuit for driving a motor, comprising:
a microcontroller having a memory; and
a drive circuit configured to drive the motor according to a control of the microcontroller;
wherein the memory include a RPM table; the microcontroller sends a duty signal to the drive circuit to change a speed of the motor according to the RPM table.

2. The control circuit as claimed in claim 1, in which the microcontroller estimates a new RPM value before sending a new duty signal to the drive circuit for changing the speed of the motor; the new RPM value is estimated according to the existed duty signal and a current RPM value.

3. The control circuit as claimed in claim 1, in which the RPM table comprises a inhibit RPM value.

4. The control circuit as claimed in claim 1, in which the speed of the motor is detected by an angle signal, wherein the motor is a sensorless motor.

5. A method for controlling a speed of a motor, comprising:
generating a control signal according to a RPM table in a memory; and
driving the motor according to the control signal,
wherein the control signal is generated by a microcontroller; the control signal is configured to drive the BLDC motor through a drive circuit.

6. The method as claimed in claim 5, in which the microcontroller estimates a new RPM value before sending a new duty signal to the drive circuit for changing a speed of the motor; the new RPM value is estimated according to a existed duty signal and a current RPM value.

7. The method as claimed in claim 5, in which the RPM table comprising the inhibit RPM value.

8. The method as claimed in claim 5, in which a speed of the motor is detected by an angle signal; the motor is a sensorless motor.
